(19) United States
(12) Patent Application Publication
(10) Pub. No.: US 2024/0239529 A1
(43) Pub. Date: Jul. 18, 2024

(54) UNMANNED AERIAL VEHICLE, PROPULSION UNIT FOR AN UNMANNED AERIAL VEHICLE, AND CONTROLLING SYSTEM FOR AN UNMANNED AERIAL VEHICLE

(71) Applicant: Singapore University of Technology & Design, Singapore (SG)

(72) Inventors: Ying Hong PHEH, Singapore (SG); Shane Kyi Hla WIN, Singapore (SG); Shaohui FOONG, Singapore (SG)

(73) Assignee: Singapore University of Technology & Design, Singapore (SG)

(21) Appl. No.: 18/577,525

(22) PCT Filed: Jul. 8, 2023
(86) PCT No.: PCT/SG2022/050483

§ 371 Date: Jan. 8, 2024

(30) Foreign Application Priority Data
Jul. 9, 2021 (SG) 10202107544P

(51) Int. Cl. B64U 30/296; B64U 10/13; B64U 30/26; B64U 30/294; B64U 30/299

(52) U.S. Cl. CPC B64U 30/296; B64U 10/13; B64U 30/26; B64U 30/294; B64U 30/299

(57) ABSTRACT

An unmanned aerial vehicle (UAV) is provided including an envelope structure configured to have a spherically curved outer surface, and a plurality of propulsion units arranged on the outer surface of the envelope structure; wherein each of the propulsion units is configured to generate an air stream along on the outer surface of the envelope structure; and wherein each of the propulsion units comprises an impeller coupled to a motor, wherein the impeller is configured to generate the air stream.

### TECHNICAL FIELD

This disclosure relates generally to an indoor unmanned aerial vehicle (UAV), propulsion units for an UAV, and controlling means for an UAV.

### BACKGROUND

Advancement of consumer small unmanned aircraft system (sUAS) technology in the recent years has enabled many applications in indoor environments such as warehouse inspections, advertising, entertainment, security, etc. Many of these applications utilized multicopter sUAS, due to its high payload capacity and high maneuverability. A multicopter's high maneuverability is essential in an outdoor environment in order to resist wind gusts, however, in an indoor environment, this high maneuverability is often unnecessary, while the other characteristics of a multicopter, such as low flight endurance, high noise signature and high safety risks, are often undesirable for indoor applications.

Compared to a multicopter, a blimp sUAS filled with helium gas may be better suited for operations in an indoor environment. A blimp sUAS can be designed to be neutrally buoyant, thus negating the need for loud, fast spinning propellers to stay airborne, and has the potential for greater flight endurance, as it only expends energy when movement is required. Due to a blimp's lighter than-air nature, the safety risk of a collision with nearby object or human is significantly lower as compared to a multicopter. However, conventional blimp design still utilizes propellers, which poses cutting hazard to any object that comes into contact. While attempts have been made to surround the propellers with protective structure to prevent contact, the design of such structures are often a balancing act between the mass of the structure and the amount of protection that it offers.

In the related art, a spherical omnidirectional blimp is known that is capable of performing six degrees of freedom (6DOF) motion. The spherical omnidirectional blimp may be powered by four tetrahedral-arranged actuation units which consists of a servomotor for rotation and a motor-propeller with propeller guard. Further known is a spherical omnidirectional blimp that is powered by side-mounted electric ducted fans.

As another related art, a blimp powered by side mounted propellers designed for indoor aerial filming applications is known.

Blimps of the related art are relatively large in size and the partially exposed propellers also pose cutting and entanglement hazard to nearby humans.

Further known propulsion technologies for indoor surveillance blimps utilize ionic wind produced by an onboard ionic flyer for thrust. However, the high voltage nature of an ionic propulsion system makes it unsafe to be operated around human beings and objects sensitive to electrical discharge.

Further known is the use of a piezoelectric microblower to circumvent the use of a propeller on a spherical blimp. However the thrust generated is weak and insufficient to propel the blimp to walking speed.

The Coandã effect has not been successfully tested on a lighter-than-air aerial vehicle as a main propulsion method.

### BRIEF DESCRIPTION OF THE DRAWINGS

Throughout the drawings, like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1A and FIG. 1B exemplarily show unmanned aerial vehicles having impeller-based propulsion units in a schematic view;

FIG. 2A to FIG. 2C exemplarily show impeller-based propulsion units for an unmanned aerial vehicle;

FIG. 3A to FIG. 3E exemplarily show various arrangements of propulsion units at unmanned aerial vehicles;

FIG. 4 shows a table illustrating the positions of the propulsion units of the unmanned aerial vehicles of FIG. 3A to FIG. 3D;

FIG. 5 shows a flow diagram of a method to control the propulsion units of an unmanned aerial vehicle; and

FIG. 6 shows a diagram of a controlling system for controlling a position of an unmanned aerial vehicle (UAV) in an indoor environment.

### DESCRIPTION

The following detailed description refers to the accompanying drawings that show, by way of illustration, specific details and aspects in which the disclosure may be practiced. One or more aspects are described in sufficient detail to enable those skilled in the art to practice the disclosure. Other aspects may be utilized and structural, logical, and electrical changes may be made without departing from the scope of the disclosure. The various aspects described herein are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa. Throughout the drawings, it should be noted that like reference numbers are used to depict the same or similar elements, features, and structures.

Illustratively, a lighter-than-air, small unmanned aircraft system (sUAS) in the form of a spherical blimp that is propelled with Coandã effect using an electric propulsion method utilizing closed impellers is provided to reduce safety risks to nearby human or objects. The sUAS may be an unmanned aerial vehicle (UAV), e.g. a drone. The UAS may be configured as a blimp. A blimp, or non-rigid airship, may have an envelope structure that is free of an internal structural framework or a keel. A blimp may rely on the pressure of the lifting gas, e.g. helium, inside the envelope structure and the strength of the envelope itself to maintain their shape.

Spherical Indoor Coanda Effect Drone (SpICED) is a safe spherical blimp sUAS design propelled by electric propulsion units made up of motor-driven closed impellers utilizing the Coanda effect. Unlike multi-copter or conventional propeller blimp, the closed impellers reduce safety risks to surrounding people and objects, allowing SpICED to be operated in close proximity with humans and opening up possibility of novel human-drone interactions. The propulsion units produce aerodynamic lift on the blimp's surface by accelerating airflow which attaches onto the spherical surface due to the Coanda effect. The spherical shape of the blimp allows the placement of propulsion units on the surface to produce thrust and torque in any desired direction. The unique placement configuration of the propulsion units combined with customized control algorithm allows the SpICED spherical blimp sUAS to be controlled to move and rotate with six degrees of freedom.

In an indoor environment with close proximity with humans and other obstacles, a conventional multicopter sUAS is unsuitable to be deployed due to safety hazards. A blimp sUAS that is neutrally buoyant in the air can reduce the safety risks in such environment. However, conventional blimp sUAS design still uses propellers which poses cutting risks to nearby human and objects.

The described propulsion system including the propulsion units and control algorithm eliminates the cutting risk so that a spherical blimp sUAS can operate safely in indoor environment, and opens up new applications and novel human-UAV interactions in which safety is the highest priority.

As an example, an UAV may utilize multiple closed impellers as propulsion units affixed on the surface of the spherical helium gas envelope structure to provide thrust and torque that allows for omnidirectional translation and rotation of the UAV. The closed impeller ensures that sharp edges are not exposed to the surrounding and further reduces the safety risks of the UAV. The spherical shape of the blimp envelope structure may cause that the Coanda effect is equally produced in all radial directions.

Compared to a multicopter, a blimp sUAS filled with helium gas may be better suited for operations in an indoor environment. It can be designed to be neutrally buoyant, thus negating the need for loud, fast spinning propellers to stay airborne, and has the potential for greater flight endurance, as it only expends energy when movement may be required. Due to a blimp's lighter-than-air nature, the safety risk of a collision with nearby object or human may be significantly lower as compared to a multicopter.

The SpICED blimp sUAS design makes use of closed impellers as its method of propulsion, which ensures that there may be no sharp/fast rotating edges exposed to the surroundings and significantly lowers the safety risks of operating a sUAS in an indoor environment. The closed impeller propulsion unit on the SpICED design may be safe enough to the point where a person can touch the spinning closed impeller in operation without any negative effect. Combined with the reduced safety risk of a blimp sUAS as compared to a multicopter sUAS in the event of electrical malfunction, the SpICED sUAS design may be safe to be operated in close proximity with humans in an indoor environment. This means the SpICED sUAS has the potential to be utilized in indoor applications such as aircraft inspection, with minimal manpower, safety requirements and negative impact on existing workflow.

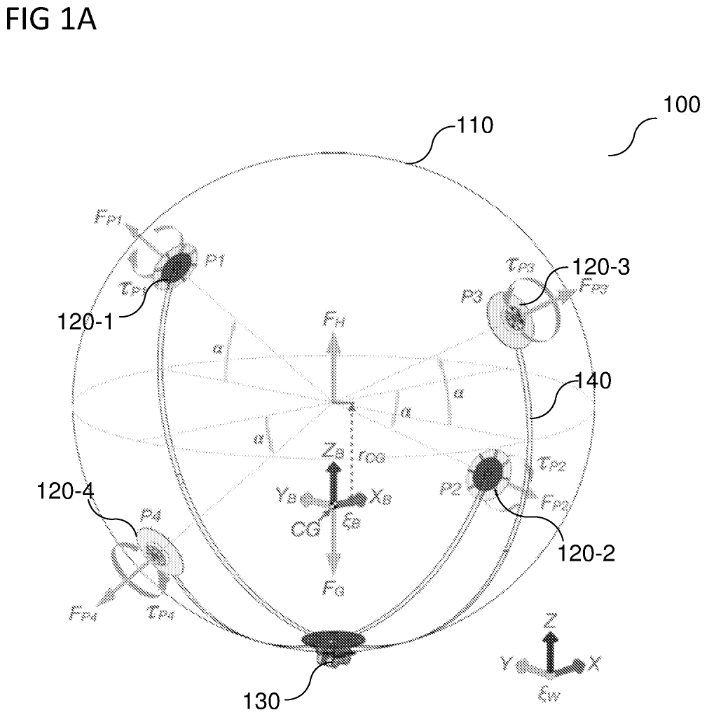

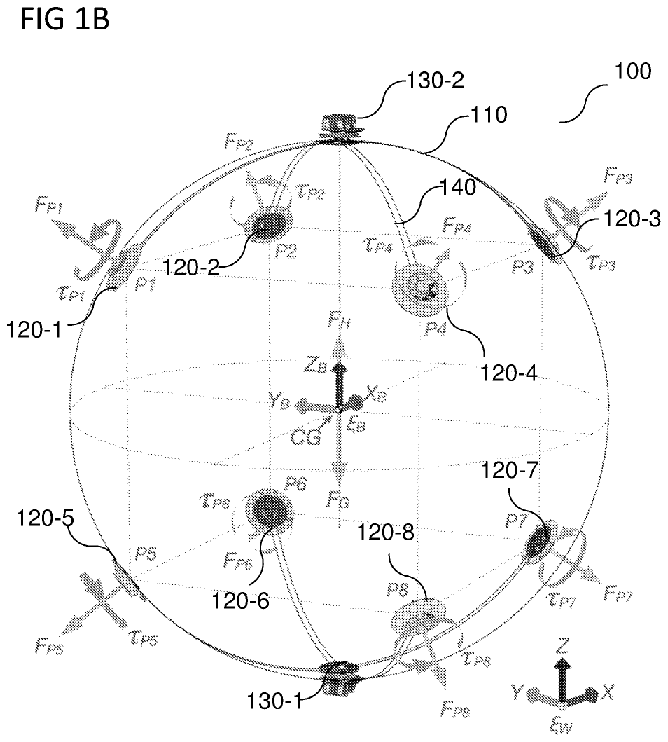

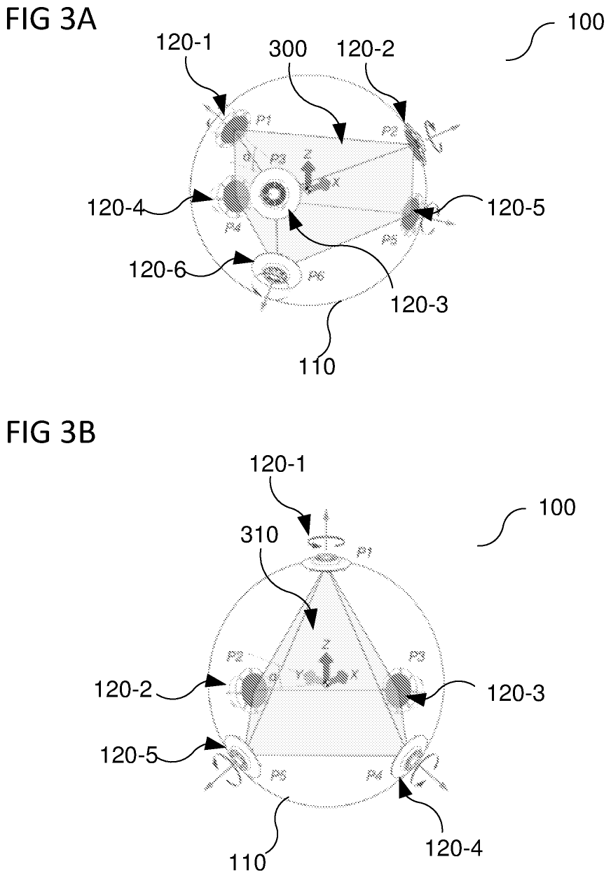

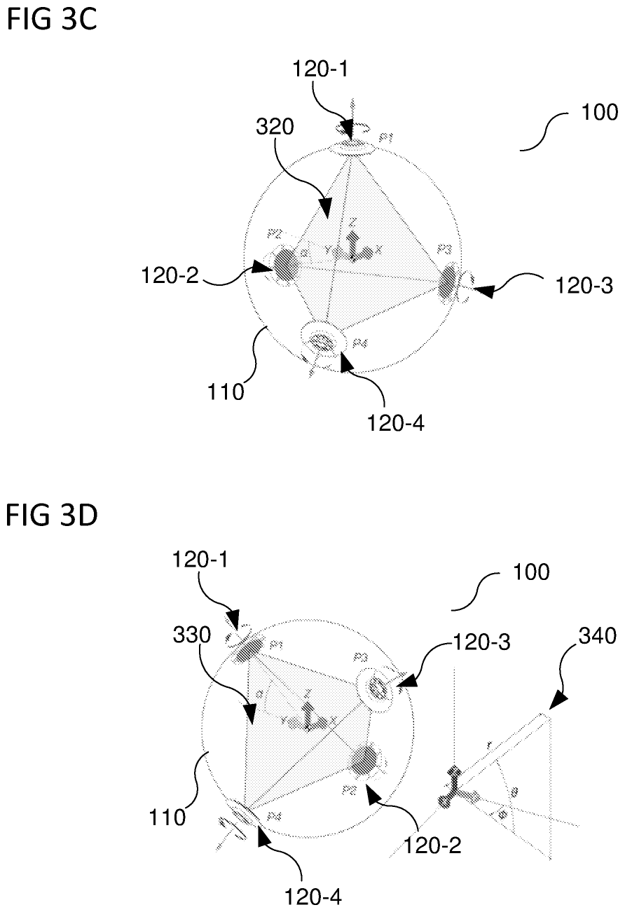

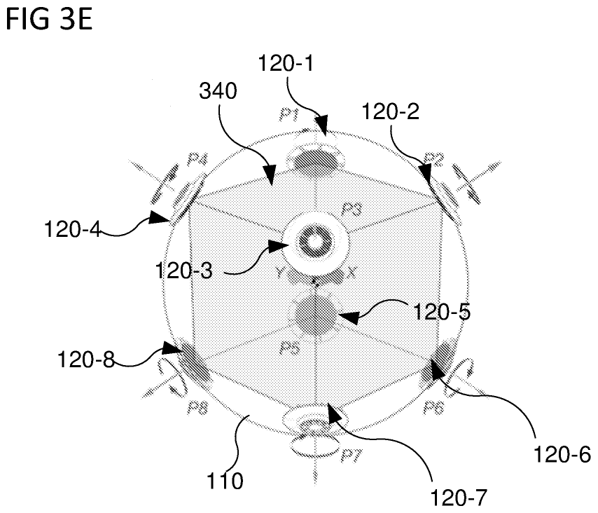

FIG. 1A and FIG. 1B exemplarily show unmanned aerial vehicles having impeller-based propulsion units in a schematic view. FIG. 1A and FIG. 1B show the free body diagram of one of the configuration for SpICED which may be the Side-Tetrahedron (see FIG. 1A and FIG. 3D) or cubic (see FIG. 1B and FIG. 3E). In FIG. 1A and FIG. 1B, the world frame is denoted as w and the body frame is denoted as s. Illustrated in FIG. 1A is a UAV 100 having four propulsion units 120-1, 120-2, 120-3, 1204 attached to the outer surface of a spherical blimp envelop structure. The first propulsion unit 120-1, P1 and the third propulsion unit 120-3, P3 are aligned to the YZ-plane and angled upwards from the XY-plane by α. The second propulsion unit 120-2, P2 and the third propulsion unit 120-4, P4 are aligned to the XZ-plane, and angled downwards from the XY-plane by a. The angle α may be a design parameter (0<α<π/2) that may determine the ratio of horizontal thrust vs vertical thrust produced by the propulsion units 120-N.

In FIG. 1A, the back side of the first propulsion unit 120-1 and the second propulsion unit 120-2 is illustrated. The back side is attached to the envelop structure 110. Further, the front side of the third propulsion unit 120-3 and the fourth propulsion unit 120-4 is illustrated. The front side faces the outer scene of the UAV 100.

The first propulsion unit 120-1 and the third propulsion unit 120-3 may be a top pair propulsion units due to their location on the top hemisphere of the spherical envelop structure 110, and the second propulsion unit 120-2 and the fourth propulsion unit 120-4 may be a bottom pair as located on the bottom hemisphere of the spherical envelop structure 110.

Each of the propulsion units 120-N may produce thrust F_{P} and torque T_{P}, as given in Equations (4) and (5) respectively. Due to the battery, control unit 130 and the payload of the UAV 100 mounted below the envelop structure 110, the center of gravity (CG) of the UAV 100 may be directly below the geometric center of the spherical body by a distance of r_{CG} along Z_{B} axis. In FIG. 1A only the control unit 130 is illustrated. However, the battery and payload may be co-located with the control unit 130, e.g. in a compact module.

Here, the UAV 100 is assumed to be neutrally buoyant with lifting force of helium gas F_{H} cancelling out the gravity force F_{G}. Due to the distance offset r_{CG} between F_{H} and F_{G}, there exists a natural restoring moment in pitch and roll motions of the UAV 100 which can be caused by forces and torques from the propulsion units 120-N and also by external disturbances.

In other words, the UAV 100 may include an envelope structure 110 and a propulsion system. The propulsion system may include a plurality of propulsion units 120-N with N being an integer. In FIG. 1A N is “4”, and hence the UAV 100 includes a first propulsion unit 120-1, a second propulsion 120-2, a third propulsion unit 120-3, and a fourth propulsion unit 120-4.

In FIG. 1B, the UAV 100 includes 8 propulsion units 120-1, 120-2, 120-3, 120-4, 120-5, 120-6, 120-7 and 120-8. Hence, N is 8 in FIG. 1B. Further in FIG. 1B, the UAV 100 may include a plurality of control units 130, e.g. a first control unit 130-1 and a second control unit 130-2. Each of the control units 130-1, 130-2 may be configured to control a subset of the plurality of propulsion units 120-N. As an example, the first control unit 130-1 may control the first, second, third and fourth propulsion units 120-1, 120-2, 120-3, 120-4, and the second control unit 130-1 may control the fifth, sixth, seventh, and eighth propulsion units 120-5, 120-6, 120-7, 120-8. The control units 130-1, 130-2 may be communicatively coupled with each other. As an example, only one of the subsets of propulsion units may be operated at a time, e.g. depending on the orientation of the UAV 100 in the scene of the UAV 100. The control units 130-1, 130-2 may communicate which one of the control units 130-1, 130-2 is to be operated, e.g. the operational timing, and to which extent (e.g. lift force). For the ease of explanation, the control unit 130 is described to control a plurality of propulsion units 120-N. However, the control unit 130 may be one control unit of a plurality of control units 130-1, 130-2, and the plurality of propulsion units 120-N may be a subset of a plurality of propulsion units, or may be the total plurality of propulsion units.

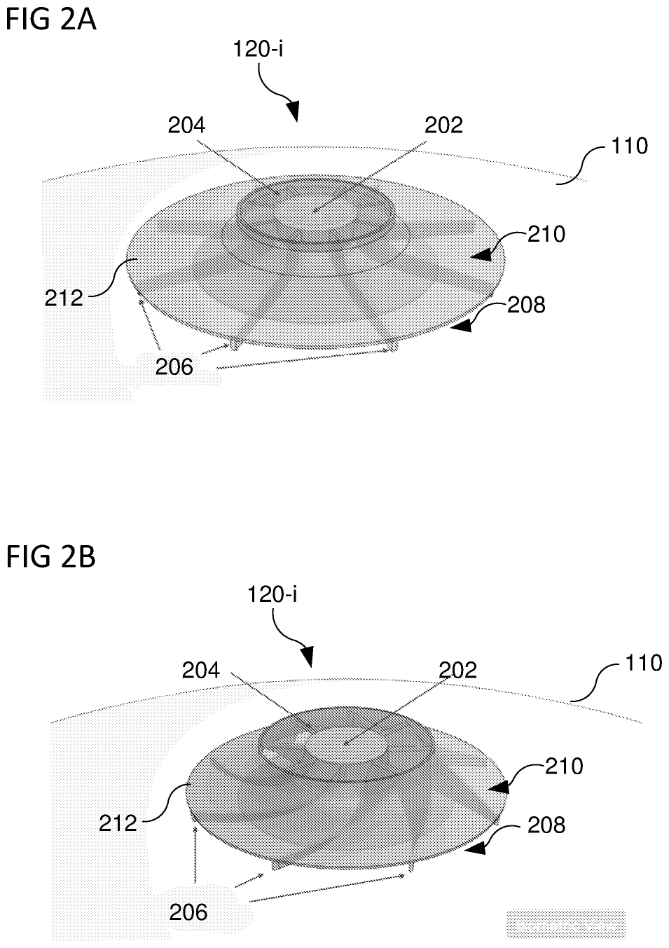

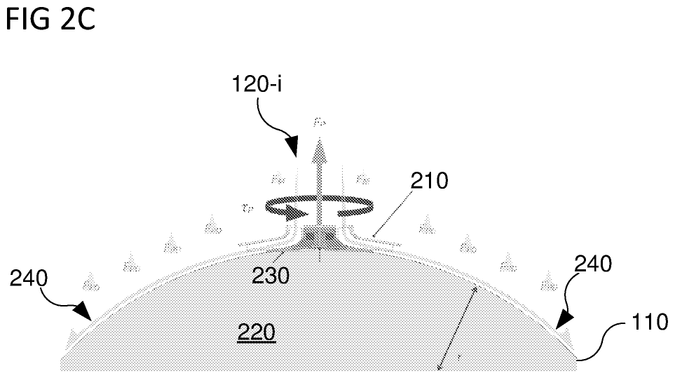

The total lift forces generated by the Coandã effect blanket on a semi-spherical Coandã effect is:

$${F}_{P} = {F}_{M} + {F}_{PD} \qquad ( 1 )$$

where F_{P} stands for the net thrust, F_{M} stands for vertical lift forces due to the momentum balance of the Coandã blanket and F_{PD} stands for the lift forces due to pressure difference on the envelop structure 110 subject to the Coandã blanket, as shown in FIG. 2C.

The thrust F_{P} and torque τ_{P} (e.g. the reaction torque from spinning of the impeller) produced by a propulsion unit 120-i may be approximated as follows:

$${F}_{P} = {β}_{t} {ω}^{2} \qquad ( 2 )$$

$${τ}_{P} = {β}_{d} {ω}^{2} \qquad ( 3 )$$

where βₜ may be the impeller thrust coefficient and β_{d} may be the impeller drag coefficient, both of which may be determined empirically. The coefficients can be calculate using experimental method where a force-torque sensor may be used to measure the thrust and torque produced by the propulsion unit 120-i, F_{P} and τ_{P}, and the rotational speed, a of the impeller 210 may be measured using the Electronic Speed Controller (ESC) by measuring the back electromotive force produced by the spinning of the DC brushless motor 202.

As each propulsion unit 120-i may be only capable of producing thrust and torque along a single axis, multiple propulsion units 120-N may be used on a spherical blimp sUAS in order to achieve a necessary flight control. As an example, a minimum flight control requirement for a typical blimp may be the ability to translate in three-dimensional space, and rotate about the yaw-axis. However, the ability to perform omnidirectional rotation may be beneficial for applications where it is necessary for a fixed camera on the blimp to point in any direction.

The sum of forces and moments acting on the model can be summarized as:

$$\sum F = {F}_{P 1} + {F}_{P 2} + {F}_{P 3} + {F}_{P 4} + {F}_{H} + {F}_{G} \qquad ( 4 )$$

$$\sum M = {τ}_{P 1} + {τ}_{P 2} + {τ}_{P 3} + {τ}_{P 4} + ( {r}_{CG} \times {F}_{H} ) + ( {r}_{P 1} \times {F}_{P 1} ) + ( {r}_{P 2} \times {F}_{P 2} ) + ( {r}_{P 3} \times {F}_{P 3} ) + ( {r}_{P 4} \times {F}_{P 4} ) \qquad ( 5 )$$

where r_{P1}, r_{P2,} r_{P3} and r_{P4} are position vectors of the respective PUs with respect to ξ_{B}.

Using Newton-Euler equations, the translational and rotational dynamics of the UAV 100 can be written as:

$$\{ \begin{matrix}m \dot{v} = \sum F \\ I {\dot{ω}}_{B} = - {ω}_{B} \times I {ω}_{B} + \sum M\end{matrix} \qquad ( 6 )$$

where m may be the mass of the UAV 100, I may be the moment of inertia of the UAV 100 about its center of gravity (CG), and ω_{B} may be the angular velocity (also denoted as rotational speed) of the UAV 100.

Illustratively, the propulsion units may directly accelerate an airflow along on the outer surface of the envelope structure. Accelerated airflow may be an airstream. Each of the propulsion units may generate an airstream that is independent from the airstreams generated by another propulsion unit. An airstream may stick to the curved surface of the spherical envelop structure, e.g. due to the Coanda effect. The airstream creates a lower air pressure above the surface of the envelop structure. The lower air pressure may produce an aerodynamic lift on the envelop structure. The propulsion units 120-N provide thrust and torque that allows for omnidirectional translation and z-axis rotation of the blimp UAV 100.

The envelop structure may have a spherical shape to produce the Coandã effect equally in all radial directions. However, the shape of the envelop structure is not limited to a sphere. The envelop structure may have any other kind of shape as long as the airstream sticks to the surface of the envelop structure. As an example, the envelop structure may have the shape of an ellipsoid or similar.

In other words, the envelope structure 110 may be configured to have a spherically curved outer surface, e.g. during aerial operation. The plurality of propulsion units 120-N may be arranged on the outer surface of the envelope structure 110. The outer surface of the envelope structure may be the surface potentially in contact with the environment of the UAV 100, e.g. person in the environment of the UAV 100.

Each of the propulsion units 120-N may be configured to generate an air stream 240 (see FIG. 2C) along on the outer surface of the envelope structure 110. Each of the propulsion units may include an impeller coupled to a motor. The impeller may be configured to generate the air stream. The term “along on the surface” may be understood that the air stream is in close proximity to the surface along the surface such that the air stream sticks to the surface according to the Coanda effect.

The UAV 100 may further include a control unit 130 or a plurality of control units 130-1, 130-2 (see FIG. 1B). A control unit 130 may be configured to control the plurality of propulsion units 120-N or a subset thereof, the control unit configured to: determine a current position of the unmanned aerial vehicle 100; determine a difference between a preset position of the UAV 100 and the current position of the UAV 100; determine one or more propulsion units 120-i (see e.g. FIG. 2A and FIG. 2B) of the propulsion units 120-N (with i being a number between 1 and N) able to reduce the determined difference; and operate the determined one or more propulsion units 120-i for a predetermined time period. The predetermined time period may depend on the determined difference (e.g. the larger the difference the longer the time period), or may be a preset time period (e.g. in the range of 0.5 s to 5 s). The described procedure may be repeated after the predetermined time period.

The envelope structure 110 may be formed as a hollow sphere or a hollow ellipsoid. As an example, the envelope structure 110 may be configured as a blimp. The blimp envelop structure 110 may be inflated during aerial operation. However, the blimp envelop structure 110 may also be deflated while attaching the propulsion units 124-N to the envelop structure 110, during shipping of the UAV 100, or while maintaining or storing the UAV 100.

The envelope structure 110 may be configured to be impermissible to helium gas. As an example, the blimp envelop structure 110 may be filled with helium gas, and the helium gas may be a lifting gas for the UAV 100. The lifting gas may be a floating gas.

The envelope structure 110 may include a gas inlet. The gas inlet may be configured to adjust the amount of helium gas in the blimp envelop structure 110, for example.

The envelope structure 110 may be formed of an elastic material. The elastic material may be a plastic, e.g. a rubber-like plastic. This allows a compact storage of the UAV 100 by folding the envelop structure 110 when not used. Alternatively, or in addition, this may reduce possible safety hazards as the envelope structure 110 is able to bounce from surfaces in the environment of the UAV 100 without damaging the environment or the envelop structure 110.

In aerial operation of the UAV 100, the envelope structure 110 may include a center position (in FIG. 1A and FIG. 1B the center of the sphere). A center of mass of the UAV 100 may be arranged in a distance r_{CG} to the center position of the envelope structure 110. This may provide a stabilized orientation of the control unit 130.

The UAV 100 further may include a connection structure 140 configured to couple the propulsion units 120-N with the control unit 130. The connection structure 140 may be arranged on the outer surface of the envelope structure 110.

As illustrated in FIG. 2C, the envelop structure 110 further may include a plurality of mounting structures 230. Each mounting structure 230 may be configured to mount a propulsion unit 120-i via an adhesive on the envelop structure 110. The mounting structures 230 may define predetermined position for the propulsion units, and, thus, may allow an easy assembly of the UAV 100. As an example, the envelope structure 110 may be operationable with various numbers of propulsion units 120-i (see FIG. 3A to FIG. 3E). However, the individual position of the propulsion units 120-i may depend on the total number of propulsion units 120-N. Thus, the mounting structures 230 may indicate the predefined positions for each of the propulsion units 120-i depending on the total number of propulsion units 120-N.

FIG. 2A to FIG. 2C exemplarily show impeller-based propulsion units for an unmanned aerial vehicle.

Illustratively, as illustrated in FIG. 2A to FIG. 2C, each propulsion unit 120-i may be made up of a closed impeller 210, attached to the rotor of a direct current (DC) electric brushless motor 202. The base of the motor 202 may be attached on a mounting plate 230 as a mounting structure 230 of the envelop structure 110. The mounting plate 230 allows the propulsion units 120-i to be mounted on the surface of the blimp envelop structure 110 with the use of adhesive. The electric brushless motor 202 spins up the impeller 210, which in turn draws in air from the inlet of the impeller 210 and eject the accelerated airflow 240 (also denoted as airstream 240) radially outwards over the surface of the blimp envelop structure 110. Aside from the lift forces produced by the accelerated airflow, the rotation of the rotor and impeller 210 produces a reaction torque on the blimp envelop structure 110. This reaction torque can be utilized to manipulate the orientation of the UAV 100 in flight.

In other words: The propulsion unit 120-i may include a motor 202 and an impeller 210 coupled to the motor 202. The impeller 210 is rotatably connected to the motor 202, e.g. a movable shaft of the motor 202.

The impeller 210 may include a covering structure 212 and a plurality of vanes 206 attached to the covering structure 212. A vane 206 may also be a blade or a wing. The vanes 206 may include or may be formed in a straight shape (see FIG. 2A) or bend shape (see FIG. 2B). A bend shape may be a curved shape.

The vanes 206 and the covering structure 212 may be formed from one piece, e.g. one piece of plastic.

The propulsion unit 120-i includes an air inlet section 204 and an air outlet section 208 that are coupled through a channel structure.

In the air inlet section 204 of the impeller 210 one portion of the vanes 206 may be coupled to the motor 202 and the impeller 210 may be free of covering structure 212. In the air outlet section 208 of the impeller 210 the impeller 210 may be free of covering structure 212.

Adjacent vanes 206 of the plurality of vanes 206, the covering structure 212 and the motor 202 form a channel structure. The channel structure includes a first cross-sectional area at the air inlet section 204 and a second cross-sectional area at the air outlet section 208. The second cross-sectional area may be smaller than the first cross-sectional area. This way, according to the Bernoulli equations, the velocity of the air drawn into the air inlet 204 is increased at the air outlet 208 generating an air stream 240. The vanes 206 may act as a spacer for the covering structure 212 while attaching the propulsion unit 120-i to the envelop structure 110. This way, a predefined ratio of first cross-sectional area to second cross-sectional area can be set.

The envelop structure 110 forms a boundary of the channel structure. In other words, the envelop structure 110 may be a part of the channel structure.

Illustratively, the air inlet section 204 may be arranged above the mounting structure 230 surrounding the motor 202, and the air outlet section 208 may be arranged lateral to the mounting structure 230 surrounding the motor 202. The design of the impeller 210 can vary, for example the impeller 210 vanes can be backward curved.

FIG. 3A to FIG. 3E exemplarily show various arrangements of propulsion units at unmanned aerial vehicles. Several configurations for the placement of the propulsion units 120-N can be utilized as shown in FIG. 3A to FIG. 3E. Depending on the application, it may be favorable to choose a configuration that utilizes less propulsion units 120-N as it reduces the total mass of the propulsion system. This way, a bigger portion of the mass budget of the UAV 100 may be allocated to the battery and a payload.

FIG. 3A illustrates an UAV 100 having six propulsion units 120-1 . . . 120-6 arranged in a prismatic arrangement 300 on the outer surface of the envelop structure 110.

FIG. 3B illustrates an UAV 100 having five propulsion units 120-1 . . . 120-5 arranged in a pyramidal arrangement 310 on the outer surface of the envelop structure 110.

FIG. 3C and FIG. 3D illustrate UAVs 100 having four propulsion units 120-1 . . . 120-4 arranged in tetrahedrical arrangements 320, 330 on the outer surface of the envelop structure 110. FIG. 3C may illustrate a tetrahedron arrangement of propulsion units 120-N, and FIG. 3D may illustrate a side-tetrahedron arrangement of propulsion units 120-N.

FIG. 3E illustrates an UAV 100 having eight propulsion units 120-1 . . . 120-8 arranged in a cubic arrangement 340 on the outer surface of the envelop structure 110.

For translational motion in three-dimensional space, only the thrust component from propulsion units 120-i which are facing the intended direction of motion may be necessary, while reaction torque from the other propulsion units 120-i are used to control the yaw rotational motion, and to counter any excess torque produced. So, from the design perspective, it may be favorable to position the propulsion units 120-i in a counter-rotating manner to counter the reaction torque from each of the propulsion units 120-i in order to prevent unintended rotation when only thrust may be required.

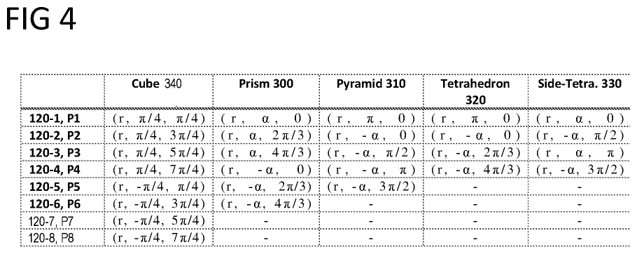

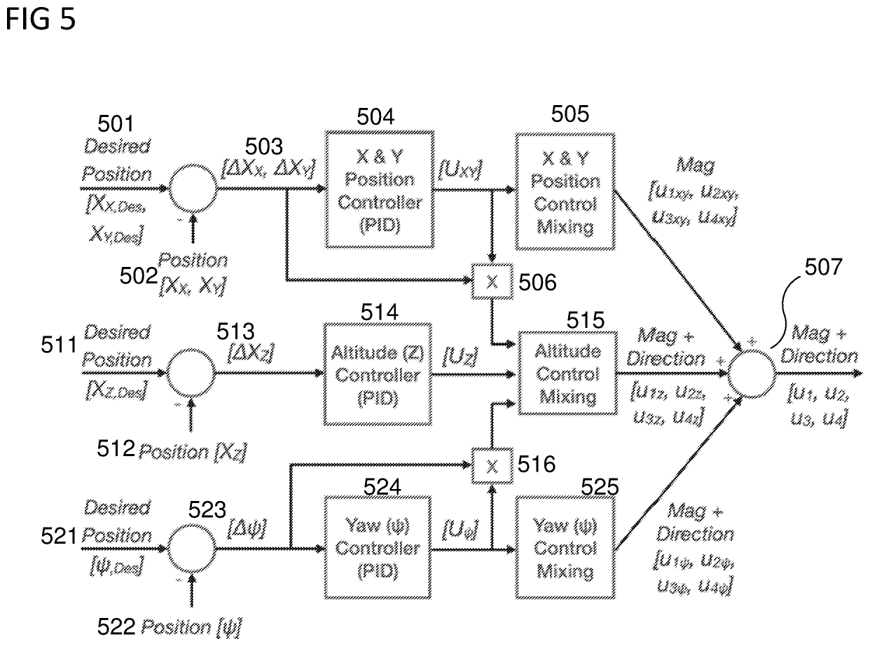

FIG. 4 shows a table illustrating the positions of the propulsion units of the unmanned aerial vehicles of FIG. 3A to FIG. 3E. Illustrated coordinates refer to the center point of the arrangement of the propulsion units 120-N.

Illustrated are spherical coordinate (r, θ, φ) with radial distance r (distance to origin), polar angle θ (angle of rotation from the XY-plane), and azimuthal angle φ (angle of rotation from the ZY-plane) of the respective propulsion unit 120-i to the center of the arrangement (see coordinate system 340 in FIG. 3D that is also used in FIG. 3A to FIG. 3C, FIG. 3E, and FIG. 4).

The center point of the arrangement of the propulsion units 120-N may be identical to a geometrical center point of the envelop structure 110 and/or a center of mass of the UAV 100.

FIG. 5 shows a flow diagram of a method to control the propulsion units of an unmanned aerial vehicle.

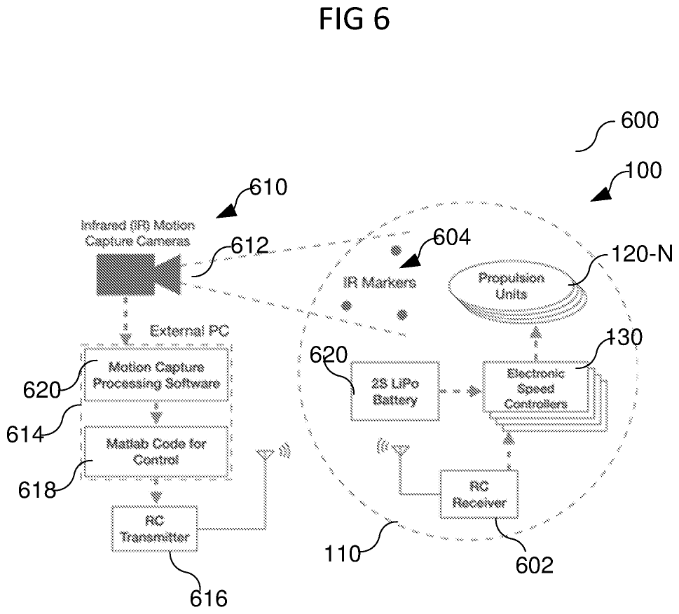

For the control of the side-tetrahedron configuration (see FIG. 1 and FIG. 3D), proportional-integral-derivative (PID) controllers 504, 514, 524 may be applied for each of the four controllable degrees of freedom 502, 512, 522, namely X, Y, Z position and yaw angle (ψ). The output from the controllers 504, 514, 524 may be fed into a unique control output mixer 505, 515, 525, 506, 516 that maps the controller output to command 507 for each propulsion unit 120-i, illustrated as [u1, u2, u3, u4] in FIG. 6.

The thrust generated by the propulsion unit 120-i may be non-reversible, while a reversible torque can be generated by spinning the radially symmetric impeller 210 in either direction. As the torque from each of the impeller 210 can influence the yaw direction of SpICED, careful attention must be given to actuator output direction in control output mixing.

X and Y position control mixing may be defined as follows:

$$\{ \begin{matrix}{u}_{{1}_{Y}} = {κ}_{XY} {U}_{Y} sgn ( {u}_{1} ) max ( 0 , {U}_{Y} ) \\ {u}_{{3}_{Y}} = {κ}_{XY} {U}_{Y} sgn ( {u}_{3} ) min ( 0 , {U}_{Y} )\end{matrix} \qquad ( 7 )$$

$$\{ \begin{matrix}{u}_{{2}_{X}} = {κ}_{XY} {U}_{X} sgn ( {u}_{2} ) max ( 0 , {U}_{X} ) \\ {u}_{{4}_{X}} = {κ}_{XY} {U}_{X} sgn ( {u}_{4} ) min ( 0 , {U}_{X} )\end{matrix} \qquad ( 8 )$$

where κ_{XY} may be the mixing gain for lateral motion. The sgn(u) function verifies if the respective propulsion unit 120-i is already spinning in a certain direction in order to accumulate control output in the same direction, preventing the propulsion unit 120-i from changing its direction of spin. max(0, U) and min(0, U) functions verify whether the control signal may be positive or negative. For example, if U_{Y} may be negative, it indicates that the control unit intends to go towards negative Y direction, resulting in the activation of only u₃_{_{Y}}.

Next, a ‘flag’ function Γ(X) is defined such that:

$$Γ ( a ) = \{ \begin{matrix}1 & if abs ( a ) > {a}_{e} \\ 0.1 & otherwise\end{matrix} \qquad ( 9 )$$

where “a” may be an input to the flag function. The flag function may be used to determine if SpICED may be within a dead zone in ΔX_{X}, ΔX_{Y} and Δψ. Within the deadzone, the flag function may keep the propulsion units 120-N from rapidly alternating between either spin directions. The flag function may be used in altitude control mixing which may be defined as follows:

$$\{ \begin{matrix}{U}_{{1}_{Z}} = {κ}_{Z} {U}_{Z} sgn ( {U}_{Y} Γ ( Δ {X}_{Y} ) ) sgn ( {U}_{ψ} Γ ( Δ ψ ) ) max ( 0 , {U}_{Z} ) \\ {U}_{{2}_{Z}} = - {κ}_{Z} {U}_{Z} sgn ( {U}_{X} Γ ( Δ {X}_{X} ) ) sgn ( {U}_{ψ} Γ ( Δ ψ ) ) min ( 0 , {U}_{Z} ) \\ {U}_{{3}_{Z}} = - {κ}_{Z} {U}_{Z} sgn ( {U}_{Y} Γ ( Δ {X}_{Y} ) ) sgn ( {U}_{ψ} Γ ( Δ ψ ) ) max ( 0 , {U}_{Z} ) \\ {U}_{{4}_{Z}} = {κ}_{Z} {U}_{Z} sgn ( {U}_{X} Γ ( Δ {X}_{Y} ) ) sgn ( {U}_{ψ} Γ ( Δ ψ ) ) min ( 0 , {U}_{Z} )\end{matrix} \qquad ( 10 )$$

where κ_{Z} may be the mixing gain for altitude motion. It may be apparent within altitude control mixing that the lateral, vertical and yaw controls may be highly coupled.

Yaw control mixing may be defined as follows:

$$\{ \begin{matrix}{u}_{{1}_{ψ}} = {κ}_{ψ} {U}_{ψ} \\ {u}_{{2}_{ψ}} = - {κ}_{ψ} {U}_{ψ} \\ {u}_{{3}_{ψ}} = {κ}_{ψ} {U}_{ψ} \\ {u}_{{4}_{ψ}} = - {κ}_{ψ} {U}_{ψ}\end{matrix} \qquad ( 11 )$$

where κ_{ψ} may be the mixing gain for yaw motion. Finally, the control outputs may be all combined and sent as actuator commands as follows:

$$\{ \begin{matrix}{u}_{1} = {u}_{{1}_{Y}} + {u}_{{1}_{Z}} + {u}_{{1}_{ψ}} \\ {u}_{2} = {u}_{{2}_{Y}} + {u}_{{2}_{Z}} + {u}_{{2}_{ψ}} \\ {u}_{3} = {u}_{{3}_{Y}} + {u}_{{3}_{Z}} + {u}_{{3}_{ψ}} \\ {u}_{4} = {u}_{{4}_{Y}} + {u}_{{4}_{Z}} + {u}_{{4}_{ψ}}\end{matrix} \qquad ( 12 )$$

FIG. 6 shows a diagram of a controlling system 600 for controlling a position of an unmanned aerial vehicle (UAV) in an indoor environment.

In the example illustrated in FIG. 6, the UAV 100 may include four propulsion units 120-N mounted on the envelop structure 110. The propulsion units 120-N are controlled by a control unit 130 that includes electronic speed controllers for each of the propulsion units 120-N. The UAV 100 may further includes a power source 620, e.g. a battery back, e.g. a 2S Lithium-Polymer battery, to power the control unit 130 and the propulsion units 120-N. The UAV 100 further includes a communication interface 602, e.g. a radio controller (RC) receiver, to communicate with a communication interface 616 of a host 610 external to the UAV 100.

The host 610 may include a personal computer (PC) 614, for example. As an example, the host 610 may include a motion capture processing software 620 and a matlab code for control 618 of the UAV.

Illustratively, the controlling system 600 may include a determining means to determine a position 502, 512, 522 (see FIG. 5) of an UAV in the indoor environment; a communication means to communicate the determined position of the UAV to the UAV; and a control means to control one or more propulsion means of the UAV to reduce the difference between the determined position and a desired position 501, 511, 521 (see FIG. 5). The propulsion means are configured to generate a lift by an air stream over a spherical envelop means of the UAV.

The determining means may be arranged at least in part external to the UAV.

The determining means may include sensors, e.g. infrared (IR) sensors 612 external to the UAV, and IR markers 604 on the envelop structure of the UAV.

The communication means may include the communication interfaces 602, 616 of the host 610 and the UAV 100.

The control means may include the PC 614 of the host 610 and the control unit 130 of the UAV 100.

The processing and calculation of control output may be performed off-board from the UAV 100, as illustrated in FIG. 6. However, on-board electronics and sensors can be employed to perform on-board calculation for closed-loop control as well. In other words, the functionality of host 610 may be implemented in the UAV 100.

In the following, various examples are provided that may include one or more aspects described above.

Example 1 is an unmanned aerial vehicle (UAV) including an envelope structure configured to have a spherically curved outer surface, and a plurality of propulsion units arranged on the outer surface of the envelope structure; wherein each of the propulsion units is configured to generate an air stream along on the outer surface of the envelope structure; and wherein each of the propulsion units includes an impeller coupled to a motor, wherein the impeller is configured to generate the air stream.

In Example 2, the subject matter of Example 1 can further optionally include a control unit configured to control the plurality of propulsion units, the control unit configured to: determine a current position of the unmanned aerial vehicle, determine a difference between a preset position and the current position, determine one or more propulsion units of the propulsion units able to reduce the determined difference; and operate the determined one or more propulsion units for a predetermined time period.

In Example 3, the subject matter of Example 1 or 2 can optionally include that the envelope structure is configured as a blimp.

In Example 4, the subject matter of any one of Examples 1 to 3 can optionally include that the envelope structure is configured to be impermissible to helium gas.

In Example 5, the subject matter of any one of Examples 1 to 4 can optionally include that the envelope structure includes a gas inlet.

In Example 6, the subject matter of any one of Examples 1 to 5 can optionally include that the envelope structure is formed of an elastic material.

In Example 7, the subject matter of any one of Examples 1 to 6 can optionally include that the envelope structure is formed as a hollow sphere or a hollow ellipsoid.

In Example 8, the subject matter of any one of Examples 1 to 7 can optionally include that, in aerial operation of the UAV, the envelope structure includes a center position; and that a center of mass of the UAV is arranged in a distance to the center position of the envelope structure.

In Example 9, the subject matter of any one of Examples 1 to 8 can optionally include that the impeller includes a plurality of vanes attached to a covering structure, wherein in an air inlet section of the impeller one portion of the vanes is coupled to the motor and the impeller is free of covering structure; and wherein in an air outlet section of the impeller the impeller is free of covering structure; wherein adjacent vanes of the plurality of vanes, the covering structure and the motor form a channel structure, wherein the channel structure includes a first cross-sectional area at the air inlet section and a second cross-sectional area at the air outlet section, wherein the second cross-sectional area is smaller than the first cross-sectional area.

In Example 10, the subject matter of Example 9 can optionally include that the envelop structure forms a boundary of the channel structure.

In Example 11, the subject matter of any one of Examples 2 to 10 can optionally further include a connection structure configured to couple the propulsion units with the control unit, wherein the connection structure is arranged on the outer surface of the envelope structure.

In Example 12, the subject matter of any one of Examples 1 to 11 can optionally include that the envelop structure further includes a plurality of mounting structures each configured to mount a propulsion unit via an adhesive on the envelop structure.

In Example 13, the subject matter of any one of Examples 1 to 12 can optionally include six propulsion units arranged in a prismatic arrangement on the outer surface of the envelop structure.

In Example 14, the subject matter of any one of Examples 1 to 12 can optionally include five propulsion units arranged in a pyramidal arrangement on the outer surface of the envelop structure.

In Example 15, the subject matter of any one of Examples 1 to 12 can optionally include four propulsion units arranged in a tetrahedrical arrangement on the outer surface of the envelop structure.

Example 16 is a propulsion unit for an unmanned aerial vehicle, the propulsion unit including: a motor and an impeller coupled to the motor, wherein the impeller includes a plurality of vanes attached to a covering structure, wherein in an air inlet section of the impeller one portion of the vanes is coupled to the motor and the impeller is free of covering structure; and wherein in an air outlet section of the impeller the impeller is free of covering structure; wherein adjacent vanes of the plurality of vanes, the covering structure and the motor form a channel structure, wherein the channel structure include a first cross-sectional area at the air inlet section and a second cross-sectional area at the air outlet section, wherein the second cross-sectional area is smaller than the first cross-sectional area.

In Example 17, the subject matter of Example 16 can optionally include that the vanes and the covering structure are formed from one piece.

In Example 18, the subject matter of any one of Examples 16 or 17 can optionally include that the vanes include a straight shape.

Example 19 is a controlling system for controlling a position of an unmanned aerial vehicle (UAV) in an indoor environment, including: a determining means to determine a position of an UAV in the indoor environment; a communication means to communicate the determined position of the UAV to the UAV; and a control means to control one or more propulsion means of the UAV to reduce the difference between the determined position and a desired position; and wherein the propulsion means are configured to generate a lift by an air stream over a spherical envelop means of the UAV.

In Example 20, the subject matter of Example 19 can optionally include that the determining means is arranged at least in part external to the UAV.

In Example 21, the subject matter of any one of Example 1 to 20 can optionally include a plurality of control units, wherein each of the control units is configured to control a subset of the plurality of propulsion units.

In Example 22, the subject matter of Example 21 can optionally include that the control units of the plurality of control units are communicatively coupled with each other.

The word “exemplary” is used herein to mean “serving as an example, instance, or illustration.” Any example or design described herein as “exemplary” is not necessarily to be construed as preferred or advantageous over other examples or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

The terms “processor” or “controller” as, for example, used herein may be understood as any kind of technological entity that allows handling of data. The data may be handled according to one or more specific functions that the processor or controller execute. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “connected” or “coupled” can be understood in the sense of a (e.g. mechanical and/or electrical), e.g. direct or indirect, connection and/or interaction. For example, several elements can be connected together mechanically such that they are physically retained (e.g., a plug connected to a socket) and electrically such that they have an electrically conductive path (e.g., signal paths exist along a communicative chain).

While the above descriptions and connected figures may depict electronic device components as separate elements, skilled persons will appreciate the various possibilities to combine or integrate discrete elements into a single element. Such may include combining two or more circuits from a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc. Also, it is appreciated that particular implementations of hardware and/or software components are merely illustrative, and other combinations of hardware and/or software that perform the methods described herein are within the scope of the disclosure.

It is appreciated that implementations of methods detailed herein are exemplary in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. An unmanned aerial vehicle (UAV), comprising:
an envelope structure configured to have a spherically curved outer surface, and
a plurality of propulsion units arranged on the outer surface of the envelope structure;
wherein each of the propulsion units is configured to generate an air stream along on the outer surface of the envelope structure; and
wherein each of the propulsion units comprises an impeller coupled to a motor, wherein the impeller is configured to generate the air stream.

2. The UAV of claim 1, further comprising a control unit configured to control the plurality of propulsion units, the control unit configured to:
determine a current position of the unmanned aerial vehicle,
determine a difference between a preset position and the current position,
determine one or more propulsion units of the propulsion units able to reduce the determined difference; and
operate the determined one or more propulsion units for a predetermined time period.

3. The UAV of claim 1, wherein the envelope structure is configured as a blimp.

4. The UAV of claim 1, wherein the envelope structure is configured to be impermissible to helium gas.

5. The UAV of claim 1, wherein the envelope structure comprises a gas inlet.

6. The UAV of claim 1, wherein the envelope structure is formed of an elastic material.

7. The UAV of claim 1, wherein the envelope structure is formed as a hollow sphere or a hollow ellipsoid.

8. The UAV of claim 1, wherein, in aerial operation of the UAV, the envelope structure comprises a center position; and
wherein a center of mass of the UAV is arranged in a distance to the center position of the envelope structure.

9. The UAV of claim 1, wherein the impeller comprises a plurality of vanes attached to a covering structure, wherein in an air inlet section of the impeller one portion of the vanes is coupled to the motor and the impeller is free of covering structure;
wherein in an air outlet section of the impeller the impeller is free of covering structure; and
wherein adjacent vanes of the plurality of vanes, the covering structure and the motor form a channel structure, wherein the channel structure comprises a first cross-sectional area at the air inlet section and a second cross-sectional area at the air outlet section, wherein the second cross-sectional area is smaller than the first cross-sectional area.

10. The UAV of claim 9, wherein the envelop structure forms a boundary of the channel structure.

11. The UAV of claim 2, further comprising a connection structure configured to couple the propulsion units with the control unit, wherein the connection structure is arranged on the outer surface of the envelope structure.

12. The UAV of claim 1, wherein the envelop structure further comprises a plurality of mounting structures each configured to mount a propulsion unit via an adhesive on the envelop structure.

13. The UAV of claim 1, further comprising six propulsion units arranged in a prismatic arrangement on the outer surface of the envelop structure.

14. The UAV of claim 1, further comprising five propulsion units arranged in a pyramidal arrangement on the outer surface of the envelop structure.

15. The UAV of claim 1, further comprising four propulsion units arranged in a tetrahedrical arrangement on the outer surface of the envelop structure.

16. The UAV of, further comprising a plurality of control units, wherein each of the control units is configured to control a subset of the plurality of propulsion units.

17. The UAV of claim 16, wherein the control units of the plurality of control units are communicatively coupled with each other.

18. (canceled)

19. The UAV unit of claim 9, wherein the vanes and the covering structure are formed from one piece.

20. The UAV unit of claim 9, wherein the vanes comprise a straight shape or are formed in a straight shape.

21.-22. (canceled)
